(19) United States
(12) Patent Application Publication
(10) Pub. No.: US 2006/0165019 A1
(43) Pub. Date: Jul. 27, 2006

(54) Echo-suppression with short delay

(75) Inventors: Christophe Beaugeant, Munchen (DE); Renato Beluffi, Milano (IT); Jager Bernd, Munchen (DE); Herbert Heiss, Puchheim (DE); Norbert Seitter, Unterhaching (DE); Luca Prati, Ferrara (IT)

Correspondence Address: MORRISON & FOERSTER LLP, 1650 TYSONS BOULEVARD, SUITE 300, MCLEAN, VA, 22102, US

(73) Assignees: Siemens Aktiengesellschaft, Munchen (DE); Siemens Mobile Communications S.p.A., Milano (IT)

(21) Appl. No.: 10/532,093

(22) PCT Filed: Sep. 23, 2003
(86) PCT No.: PCT/EP03/10576

§ 371 Date: Apr. 21, 2005

(30) Foreign Application Priority Data
Oct. 22, 2002 (EP) 02023552.9

(51) Int. Cl. H04B 3/20

(52) U.S. Cl. 370/286

(57) ABSTRACT

An efficient reduction for the time delay during echo correction in a telecommunications network is made possible by a method for reducing an echo in uplink data (19 to 22) that are issued from a terminal (2, 3) of a telecommunications network (6, 8). A copy (25) of downlink data is created from downlink data (13) that are to be transmitted from the telecommunications network (6, 8) toward the terminal (3). Said copy (25) of downlink data is converted (transcoder 18) and used for the reduction (10) of echo in uplink data (21), whereas downlink data (13) are transmitted (6) toward the terminal (2, 3).

The invention relates to a method and a device for reducing echoes in uplink data (to be transmitted in a telecommunications network, coming from a terminal).

In a very wide variety of telecommunications networks (especially cellular mobile radio networks such as GSM, UMTS, CDMA-IP-based networks etc.) an echo can occur in data sent from a terminal in the direction of the mobile radio network (uplink data), which can arise because acoustic signals output at the terminal by a loudspeaker (which are based on downlink data transmitted from the network to the terminal) are output and picked up in a more or less weak form by the microphone of the terminal. The microphone of the terminal thus receives acoustic signals from the terminal user currently speaking (or using the mobile radio terminal in some other way) and additionally a weak noise in the form of the speech component of the person with whom the terminal user is speaking reproduced by the loudspeaker of the terminal (arriving as downlink data from the network at the terminal). The voice data of the terminal user recorded by the microphone and the additional (noise) data recorded by the microphone which a microphone in or on the terminal has picked up are transmitted jointly to the other party in the terminal user's call so that in addition to the voice signal of the terminal user, the latter hears his own voice as an echo (that is the voice sequence of the other party in the terminal user's call partner which was transmitted from them to the loudspeaker of the terminal, to the microphone and from the microphone via the terminal back to the other party).

For this echo cancellers=echo compensators) are proposed in mobile radio networks (known for example from www.etsi.org etc. or Jacek Biala “Mobilfunk and intelligente networks (mobile radio and intelligent networks)”, Vieweg-Verlag, ISBN 3-528-15302-4, pages 109, 127 and 344). In a switching device of a mobile radio network the data arrives as a rule via ATM AAL-2 connections or other connections, with the data being encoded in a mobile radio codec format (especially AMR format) for compressed transmission especially over the air interface. For echo cancellation speech encoded in the codec format is transcoded into a format representing the speech over the course of time for example, such as TDM (Time Division Multiplex) format (that is converted as regards encoding) and the echo (of the downlink data) contained in the uplink data coming from the terminal is reduced as far as possible by taking into account the downlink data in the uplink data (echo cancellation). By avoiding this echo the speech quality is significantly improved. However this process delays the transmission to the other party of uplink data originating from the terminal over the telecommunications network and also the transmission to the terminal of data originating from the other party as downlink data over the telecommunications network.

The object of the present invention is, for a reduction of the echo in the uplink data coming from a terminal, to optimize as efficiently as possible the delay in data by echo cancellation. The object is achieved by the objects of the Independent claims in each case.

In that, in accordance with the invention the data (downlink-data) to be sent to the terminal is copied and sent as original or as a copy to the terminal, whereas a copy or the original of the downlink data is used transcoded to reduce the echo in uplink data, on the one hand the downlink data arrives without delay at the terminal and on the other hand echo cancellers can be used simply and efficiently in a manner known per se without modification to reduce the echo in uplink data.

Further features and advantages of the invention are produced by the claims and the subsequent description of an exemplary embodiment on the basis of the drawing. The Figures show

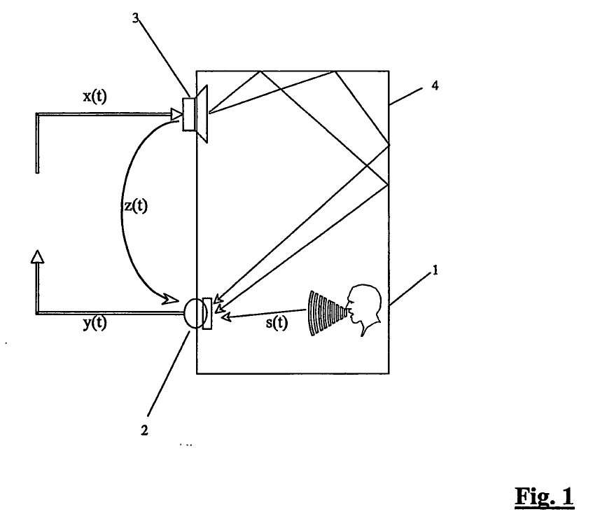

FIG. 1 a schematic diagram of how echoes are known to arise,

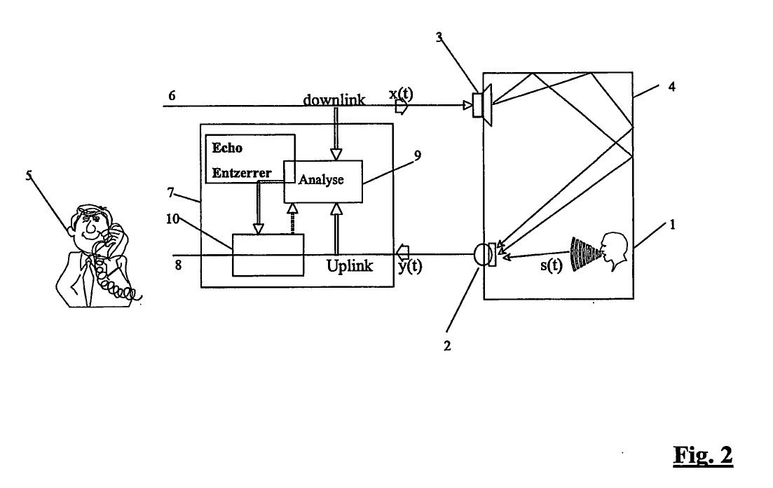

FIG. 2 echo cancellation in a telecommunications network in accordance with the invention and

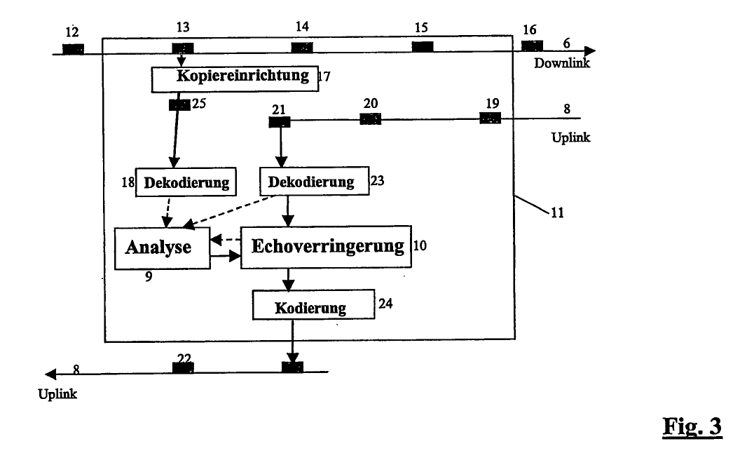

FIG. 3 reduction of the echo in accordance with the invention while avoiding the delay in the transmission of downlink data.

FIG. 1 shows a user 1 of a terminal (not shown) comprising a microphone 2 and a loudspeaker 3 which (2, 3) is located for example in a vehicle or a room 4. The loudspeaker 3 belonging to his terminal (for example also via a headset or a handsfree automobile device connected to the terminal) receives via a mobile radio network known per se and not shown and a terminal downlink data x(t), to be output acoustically which propagates in the vehicle or the room 4 and is also picked up as z(t) by microphone 2 of the terminal (or for the terminal). The microphone 2 of the terminal thus receives strongly or weakly (downlink) data sent by the partner in the call of user 1 and output by the loudspeaker 3 as well as data s(t) output by the user 1 of the terminal (2, 3) as speech etc. and transmits the sum etc of the data (recorded unwanted by loudspeaker 3 and wanted by user 1) as signal y(t) in a known way via a mobile radio terminal, an air interface etc, to the mobile radio network and onwards to the partner in the call of subscriber 1. The partner in the call of the subscriber 1 therefore perceives an echo which is to be suppressed since it reduces the speech quality.

FIG. 2 shows how, through an echo canceller, the downlink data x(t) to be transmitted by the partner 5 in the downlink 6 transmitted in a way known per se via a mobile radio network, an air interface etc. to a terminal with a loudspeaker 3 is used for echo reduction.

In accordance with the invention downlink-data x(t) transmitted over the downlink 6 is not only transmitted to the terminal with the loudspeaker 3 for acoustic output there but is copied and a copy is also analyzed independently of the transmission in the direction of the terminal (3) in an echo equalizer 7 and is used for reduction (for example subtraction in specific time segments) of the echo in uplink data y(t) to be transmitted over the uplink 8 after the analysis in an analysis direction 9 in a processor 10.

FIG. 3 illustrates what can happen here in an echo canceller 11 in a (or for a) switching device (MSC, Media Gateway etc.) of a telecommunications network (especially a mobile radio network). Data packets 12 to 16 in the downlink 6 are copied from a copying device 17 and transmitted to a transcoding device 18, which undertakes the decoding of the downlink data 13 from a mobile radio codec (etc.) encoding format into a suitable format for the echo canceller (e.g. TDM). While the downlink data copied by the coding device 17 is being transcoded in the decoding device 18 a copy (or the original) of the downlink data can already be forwarded via the downlink 6 in the direction of the terminal, which avoids a delay in transmission. Data 19 to 22 to be transmitted in the uplink 8 is also converted by a decoding device 23 (from a mobile radio codec format such as AMR etc.) into a format suitable for echo cancellation. The downlink stream data copies analyzed by an analysis device 9 (previously decoded) are analyzed by the analysis device 9 and used in the device 10 in for example a known way for echo cancellation of the uplink data transcoded via the transcoding device 23. The uplink data which now has a reduced echo or ideally no echo any more is then transcoded by a further transcoding device 24 into another format (with mobile radio for example a mobile radio codec format such as AMR or any other format) and forwarded via the uplink 8 to the other party 5 of the terminal user.

1. A method for reduction of an echo in uplink data coming from a terminal of a telecommunications network comprising:
providing a downlink data copy of downlink data to be transmitted from the telecommunications network in the direction of the terminal, coded in a mobile radio codec format, with a downlink data copy being decoded with a transcoder and used for reduction of echoes in uplink data, while downlink data is transmitted in a direction of the terminal.

2. The method in accordance with claim 1, wherein the downlink data copy and the uplink data are decoded and an echo in the decoded uplink data is removed taking into account the decoded downlink data copy.

3. The method in accordance with claim 1, wherein the telecommunications network is a cellular mobile radio network and the terminal is a mobile radio terminal.

4. The method in accordance with claim 1, further comprising decoding and encoding the downlink data copy which is only transcoded and not encoded back into the original format.

5. The method in accordance with claim 1, wherein
the uplink data coming from the terminal and the downlink data is encoded into a mobile radio codec format.

6. The method in accordance with claim 1, wherein
the transmission in the telecommunications network is undertaken at least partly packet oriented over data connections.

7. The method in accordance with claim 1, wherein
downlink data is used in each case for echo suppression in uplink data coming after it arriving at an echo canceller device including an echo of this downlink data, to take account of the data runtime, from the terminal and back and/or the acoustic signal delay time from a loudspeaker to a microphone.

8. A device for reducing an echo in uplink data to be transmitted over a telecommunications network from a mobile radio terminal, comprising;
a copying device for copying downlink data to be sent to the terminal in a downlink data copy,
a device for forwarding the downlink-data in the direction of the terminal;
a transcoding devices for transcoding the downlink data copy; and
a device for analyzing the downlink data copy for an echo suppression in the uplink data.

9. The device in accordance with claim 8, wherein
one device is provided for transcoding the downlink data copy, but no device for transcoding back into an original format.

10. The device in accordance with claim 8, wherein
the uplink data coming from the terminal is encoded into a mobile radio codec format.

11. The device in accordance with claim 8, wherein
the transmission in the telecommunications network occurs at least partly over ATM connections.

12. The device in accordance with claim 8, wherein the device includes
a delay device through which the downlink data is used in each case for echo suppression of uplink data arriving thereafter in time, including an echo of the downlink data, to take account of the data delay time from the terminal and back and/or the acoustic signal delay time from a loudspeaker to a microphone.
